(19) United States
(12) Patent Application Publication
(10) Pub. No.: US 2014/0166711 A1
(43) Pub. Date: Jun. 19, 2014

(54) PERSONAL STORAGE ACCESSORY FOR WHEELCHAIRS

(71) Applicant: DESIGN PAR MITCHELL INC., Montreal (CA)

(72) Inventor: Raymond Larry MITCHELL, Montreal (CA)

(73) Assignee: DESIGN PAR MITCHELL INC., Montreal (CA)

(21) Appl. No.: 14/106,429

(22) Filed: Dec. 13, 2013

Related U.S. Application Data
(60) Provisional application No. 61/797,690, filed on Dec. 14, 2012.

(51) Int. Cl. A61G 5/10

(52) U.S. Cl. CPC A61G 5/10
USPC 224/407

(57) ABSTRACT

A transfer device for moving a personal storage container from a storage position at the rear of a wheelchair to a deployed position at a side of the wheelchair. The device includes a bracket adapted to be mounted to the backrest frame and a swivel mechanism with a first hinge leaf rotationally mounted to the bracket for rotation about a first axis and a second hinge leaf rotationally mounted to the first hinge leaf about a second axis spaced apart from the first axis. The second hinge leaf has a portion adapted to mount the personal storage container. The portion adapted to mount the personal storage container moves along an arc contained within a plane between the storage and the deployed positions, and the first and second axes are normal to the plane. A personal storage container assembly is also provided.

### CROSS-REFERENCE TO RELATED APPLICATIONS

This application claims priority on provisional U.S. application No. 61/797,690 filed Dec. 14, 2012, the entire contents of which are incorporated by reference herein.

### TECHNICAL FIELD

The present invention relates to accessories for wheelchairs and in particular to a personal storage transfer device for a wheelchair.

### BACKGROUND OF THE ART

Several patents exist showing various personal storage devices or backpacks which are movable between a first position behind a wheelchair to a second position sideways of the wheelchair whereby the storage device is more readily accessible to the wheelchair user. Such patents include, for example, U.S. Pat. No. 4,919,443 Kehler 1990; U.S. Pat. No. 5,180,181 Letechopia 1993; and U.S. Pat. No. 8,496,260 Jutkiewicz et al. 2013. However existing storage devices may be relatively expensive and/or complex.

### SUMMARY

In one aspect, there is provided a transfer device for moving a personal storage container from a storage position at the rear of a wheelchair to a deployed position at a side of the wheelchair where the wheelchair includes a backrest frame, the transfer device comprising: a bracket adapted to be mounted to the backrest frame; and a swivel mechanism including a first hinge leaf rotationally mounted to the bracket for rotation about a first axis, and a second hinge leaf rotationally mounted to the first hinge leaf about a second axis spaced apart from the first axis, the second hinge leaf having a portion adapted to mount the personal storage container, the swivel mechanism being configurable between the storage position and the deployed position, the portion adapted to mount the personal storage container moving along an arc contained within a plane between the storage and the deployed positions, the first and second axes being normal to the plane.

In another aspect, there is provided a personal storage container assembly for a wheelchair movable between a storage position at the rear of a wheelchair to a deployed position at a side of the wheelchair where the wheelchair includes a backrest frame, the assembly comprising a personal storage container and a transfer device, the transfer device including a bracket adapted to be mounted to the backrest frame and a swivel mechanism including a first hinge leaf rotationally mounted to the bracket for rotation about a first axis, and a second hinge leaf rotationally mounted to the first hinge leaf about a second axis spaced apart from the first axis, the second hinge leaf mounting the personal storage container, the swivel mechanism being configurable between the storage position and the deployed position, the personal storage container moving along an arc contained within a plane between the storage and the deployed positions, the first and second axes being normal to the plane.

### DESCRIPTION OF THE DRAWINGS

Reference will now be made to the accompanying drawings, showing by way of illustration particular embodiments of the present invention and in which:

FIG. 1 is a side elevation, partly in dotted lines showing a typical manual wheelchair to which a personal storage transfer device in accordance with a particular embodiment is shown in full lines, mounted to the wheelchair;

FIG. 2 is a top plan view of the wheelchair of FIG. 1 with the personal storage transfer device is shown in two different positions;

FIG. 3 is a perspective view of the personal storage device in a partially deployed position;

FIG. 4 is a fragmentary, top plan view showing a detail of the embodiment shown in FIG. 3, but in a stored position behind the wheelchair;

FIG. 5 is an exploded view in side elevation of a detail of the embodiment shown in FIGS. 3 and 4;

FIG. 6 is a fragmentary, side elevational view of the detail shown in FIG. 4;

FIG. 7 is a fragmentary, top plan view of the detail shown in FIGS. 6 but in a partially deployed position;

FIG. 8 is a fragmentary, top plan view of the detail shown in FIGS. 6 and 7, but in a fully deployed position, with the storage container adjacent an armrest of the wheelchair;

FIG. 9 is a perspective view of a personal storage transfer device in accordance with another embodiment;

FIG. 10 is a fragmentary, enlarged view, in side elevation, of a detail shown in FIG. 9, but in a stored position behind the wheelchair;

FIG. 11 is a top plan view of the personal storage transfer device shown in FIG. 9;

FIG. 12 is a top plan view, similar to FIG. 11, but showing the personal storage transfer device in a partially deployed position; and

FIG. 13 is a top plan view, similar to FIG. 11, but showing the personal storage transfer device in a fully deployed position.

### DETAILED DESCRIPTION

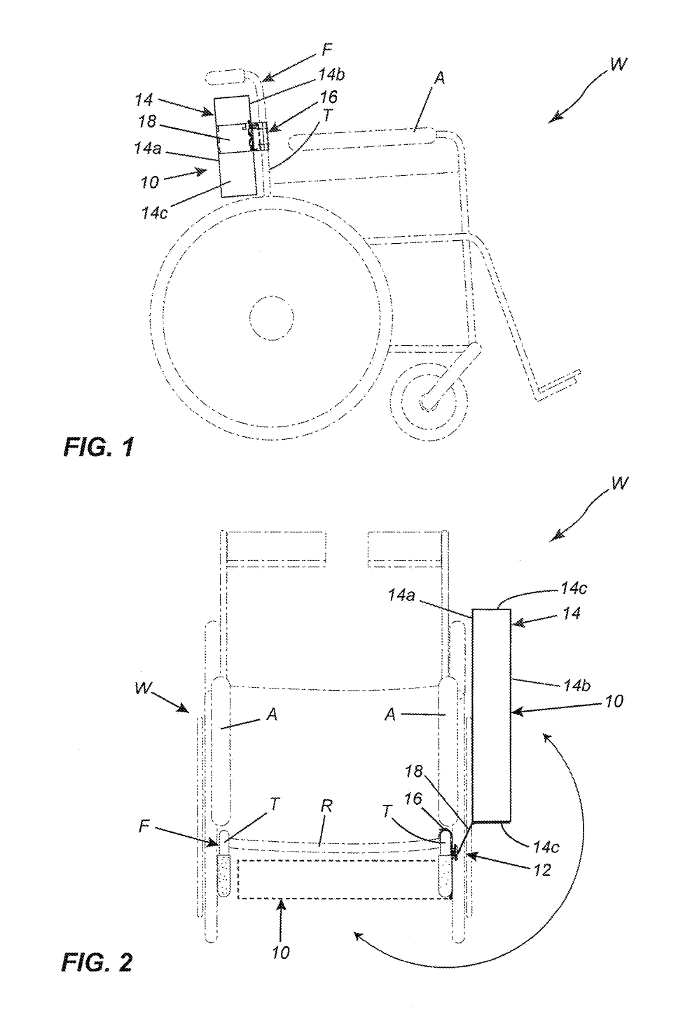

A wheelchair W is shown in FIGS. 1 and 2, in dotted lines. The wheelchair W includes a frame F having tubular frame members T on either side of a backrest R. Armrests A are also illustrated. A first embodiment of the personal storage transfer device is illustrated in FIGS. 1 and 2 showing a personal storage device 10 mounted to the tubular frame member T of wheelchair W. As shown in FIG. 2, the personal storage transfer device 10 is meant to rotate or swivel between a stored position, shown in dotted lines, at the rear of the backrest R, and an accessible position shown in full lines adjacent the armrest A.

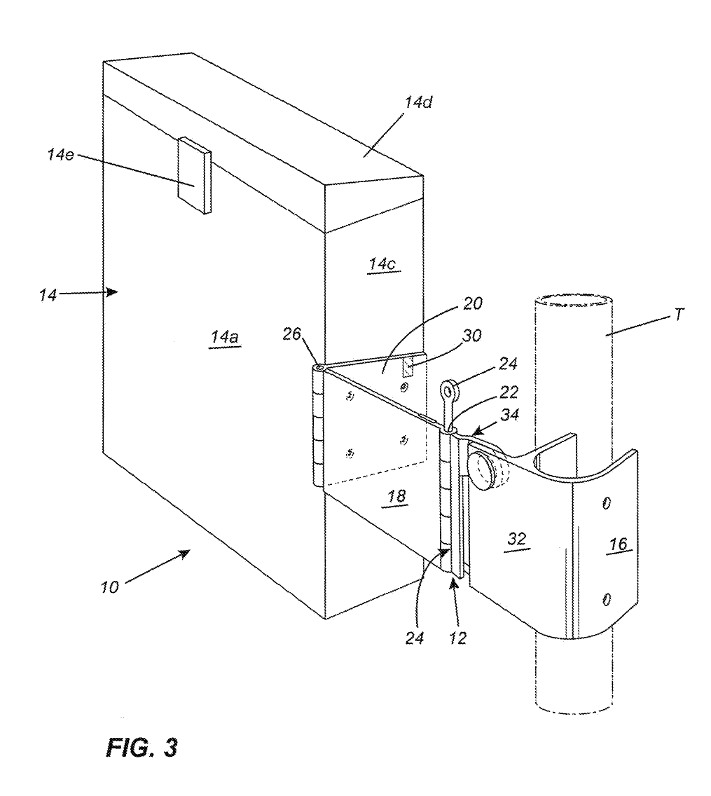

The personal storage transfer device 10 is shown in FIG. 3. A storage container 14 is illustrated as a rigid box having rectangular planar front and rear walls 14a and 14b as well as end walls 14c and a lid 14d. A clasp 14e is provided to lock the lid 14d. The storage container 14 may be of many forms such as an open basket useful to receive various loose articles, small backpacks, purses, computer bag, etc. The container 14 may also be a soft walled bag or other container suitable to be moved between a rear storage position and a side accessible position.

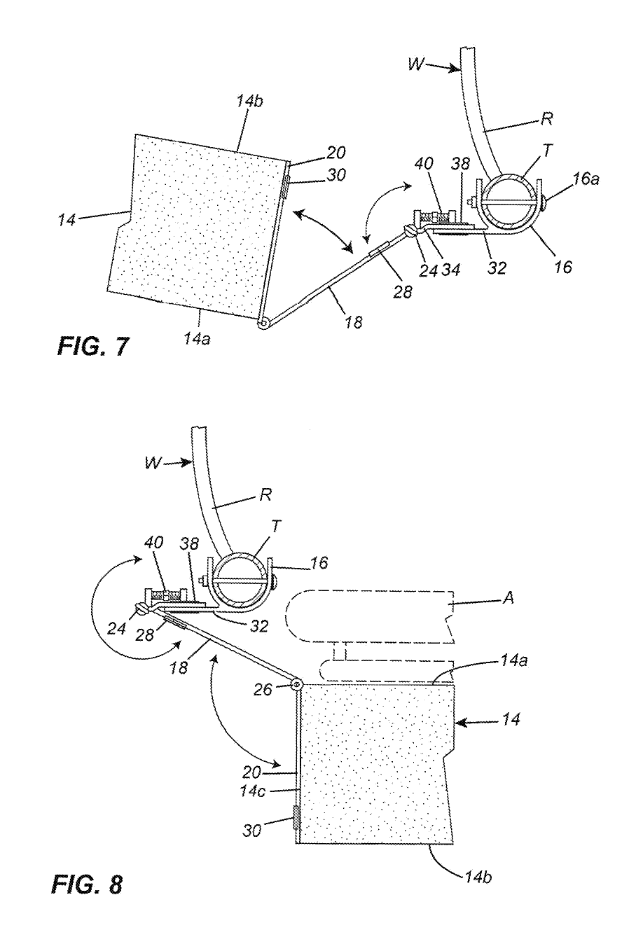

As shown in FIGS. 3 to 8, in a particular embodiment the device 10 includes a mounting bracket 16 which is adapted to be mounted to tubular frame member T. Fasteners such as nuts and bolts 16a and 16b may be used, passing through the openings provided in the bracket 16 and holes drilled through the tubular frame member T. Other clamp devices may be used to mount bracket 16 to the tubular frame member T but most wheelchair frames have coatings that may be too slippery or soft to offer suitable retention when utilizing known clamping devices. The bracket 16 has an extension 32 to which a hinge assembly 12 is integrated, as will be described hereinafter.

Hinge leaves 18 and 20 are hinged together about hinge pin 26. Hinge leaf 20 is fixed to the end walls 14c of container 14. Hinge leaf 18 is hinged to the hinge assembly 12 of the bracket 16 by means of hinge pin 22 which includes hinge pin handle 24 for easy removal of the hinge pin 22 when it is required to detach the personal carrier device 10 from the wheelchair W.

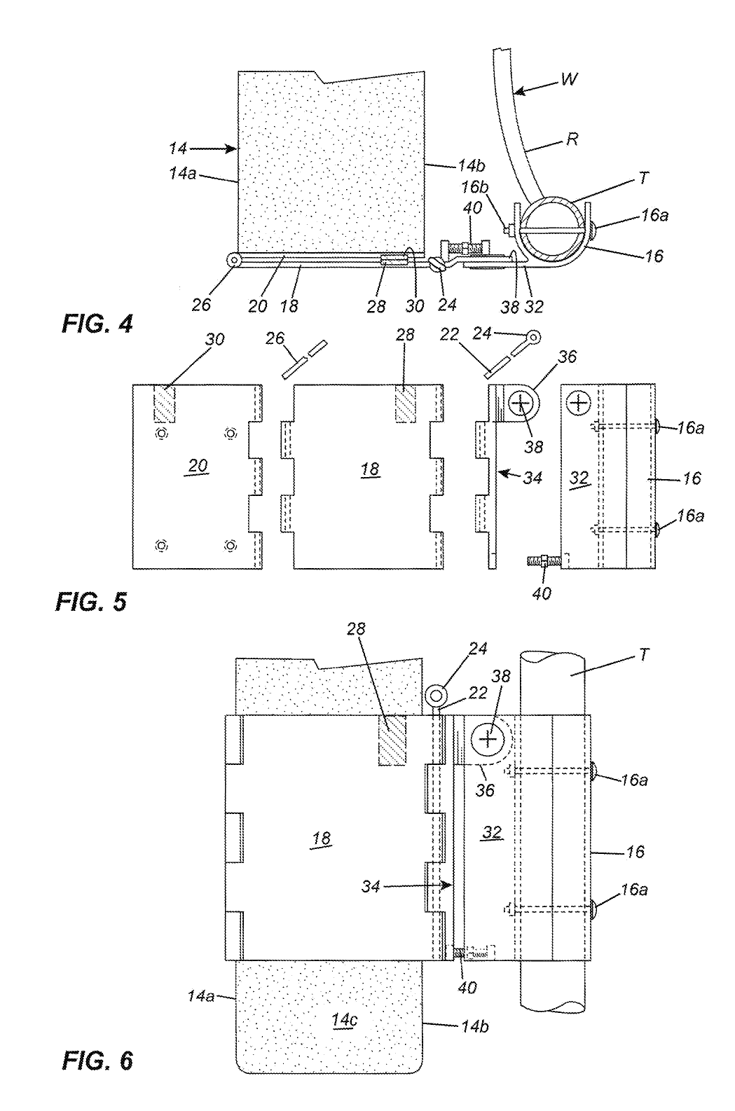

Tubular frame members T, forming the backrest support, are rarely exactly vertical. However, in a particular embodiment, it is desired to maintain the arc of rotation in a horizontal plane. Accordingly, to rotate the personal storage transfer device 10 between the rear stored position and the accessible position, a substantially vertical axis of rotation is required to maintain the arc of rotation in a horizontal plane. In a particular embodiment, the arc of rotation has an angle of about 270°. In order to provide a substantially vertical axis of rotation about a pivot pin 22, a pivot assembly is provided. In the embodiment shown, the hinge assembly 12 includes a hinge adapter 34, as shown in FIGS. 4, 5 and 6. The hinge adapter 34 is mounted to the bracket extension 32 by means of a pivot member 38 provided on tab 36 of the hinge adapter 34. Spaced from the pivot member 38 and mounted between the hinge adapter 34 and the bracket extension 32 is a threaded adjustment member 40 extending transversely to the axis of the pivot member 38. Thus, when it is required to mount a new personal storage device 10 to a wheelchair W, the bracket 16 is first fixed, or otherwise clamped, to the tubular frame member T and then the threaded adjustment member 40 is manipulated to adjust its length between the hinge adapter 34 and tab formed by the bracket extension 32 so that the hinge adapter 34 pivots about the pivot member 38 to arrive at a substantially vertical orientation for the axis represented by the pivot pin 22. In a particular embodiment, the axis of the pivot member 38 extends perpendicularly to the axis of the pivot pin 22 and within the plane of the arc of rotation of the device 10, such that the axis of the pivot pin 22 rotates in a plane perpendicular to the axis of the pivot member 38 when the length of the member 40 is adjusted.

Magnets 28 and 30 may be provided on hinge leaves 18 and 20 in order to hold the container 14 in its stored position, behind the backrest. FIGS. 4, 7 and 8 show a progressive rotational movement from a stored position shown in FIG. 4, to the accessible position adjacent armrest A, in FIG. 8. Once the user tugs on the container 14 to swivel it around, a force is applied to overcome the attraction of magnets 28 and 30.

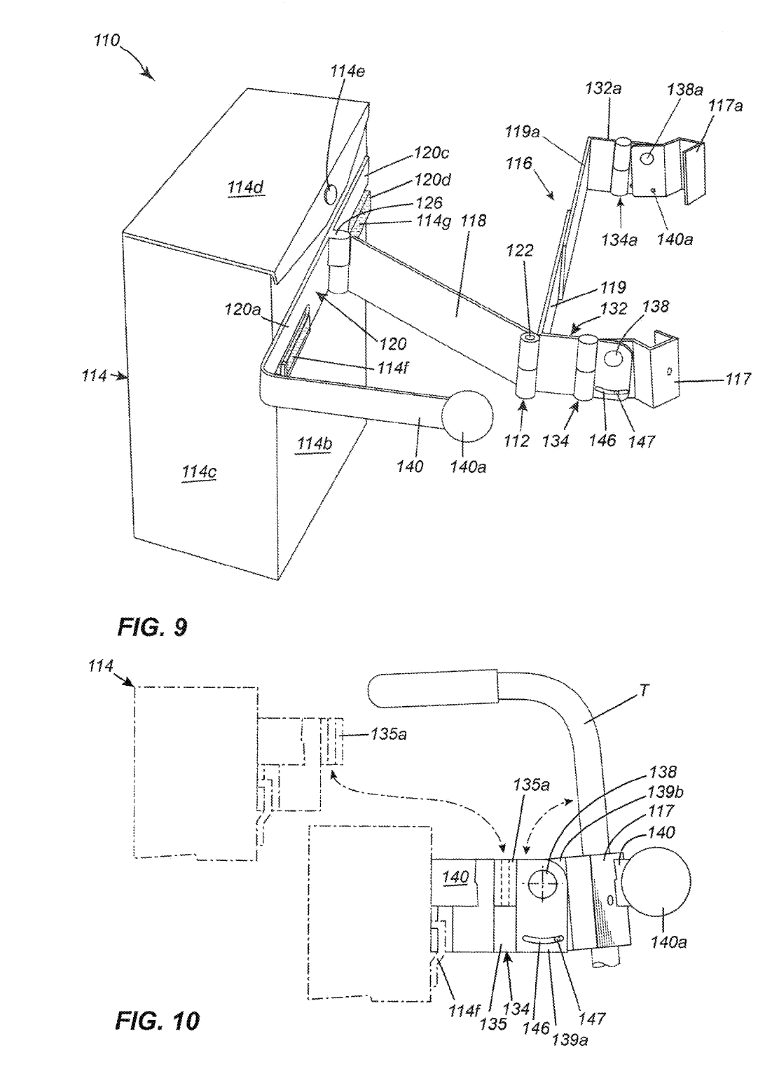

A personal storage transfer device in accordance with another embodiment is shown at 110 in FIGS. 9 through 13. In this embodiment, similar elements have been raised by 100. Typically, the backrest R of the wheelchair W has two upstanding, tubular frame members T. The bracket 116 is designed to be mounted to the two tubular frame members T of the backrest R. The bracket 116 includes a pair of spaced apart frame engaging members 117 and 117a. As shown in FIG. 10 and FIGS. 11 through 13, the engagement members 117 and 117a are mounted to the upstanding tubular frame members T, by means of fasteners. However, the engagement members 117 and 117a may be pressure clamps, as previously described with respect to the first embodiment. The bracket 116 also includes a pair of arms 119 and 119a which are extensible in order to adapt to different size wheelchairs. Fasteners F may be provided to fix the length of the adjusted arms 119 and 119a.

Between the engagement members 117 and 117a and the arms 119 and 119a is a pivot assembly. The pivot assembly is represented by pivot members 138 and 138a. This pivot assembly allows limited rotation of the bracket 116 along a horizontal axis in order to compensate for the relative non-verticality of the tubular frame members T. Each pivot assembly 138, 138a includes a pair of tabs 139a and 139b connected by the pivot pin 138. A cam slot 146 is provided in tab 139a while a cam follower 147 is located on the tab 139b, the cam follower 147 extending parallel to the axis of the pivot member 138, 138a.

A pin-and-socket 134 and 134a may also be provided adjacent the hinge assembly 138, 138a. Tabs 132 and 132a are fixed to the top half of the pin-and-socket 134 and the arms 119 and 119a respectively. The pin-and-socket 134, 134a arrangements include a pin and base 135 and a socket 135a. This pin-and-socket 134 and 134a allows the personal storage transfer device 110 to be lifted and removed from the wheelchair W, to which the frame engagement members 117 and 117a remain fastened, as shown in dotted lines in FIG. 10.

At the intersection of arm 119 and tab 132 is provided the hinge assembly 112 which includes a hinge pin 122 on which the hinge leaf 118 rotates. The hinge assembly 112 can be located either at the intersection of arm 119 and tab 132, as shown in FIG. 9, or at the intersection of arm 119a and the tab 132a.

A second hinge leaf 120 is rotationally mounted to the hinge leaf 118 by means of the hinge 126. As will be described, the hinge leaf 120 in the present embodiment is slotted at each end as represented by arms 120a 120b, 120c and 120d. A pull-arm 140 is integral with the hinge leaf 120.

The hinge leaf 120 with its slotted ends can engage any number of personal storage containers that have straps, such as a backpack. The straps are hung on arms 120b and 120d, in the slots so formed. Other devices for mounting various personal storage containers may be part of hinge leaf 120. In one of embodiment, the personal storage container may be in the form of a rigid walled container 114. On the rear wall 114b, a pair of sleeves 114f and 114g may be provided to be engaged by arms 120b and 120d respectively. The sleeve 114g, in this embodiment can be opened and closed over the arm 114g by means of a Velcro fastener.

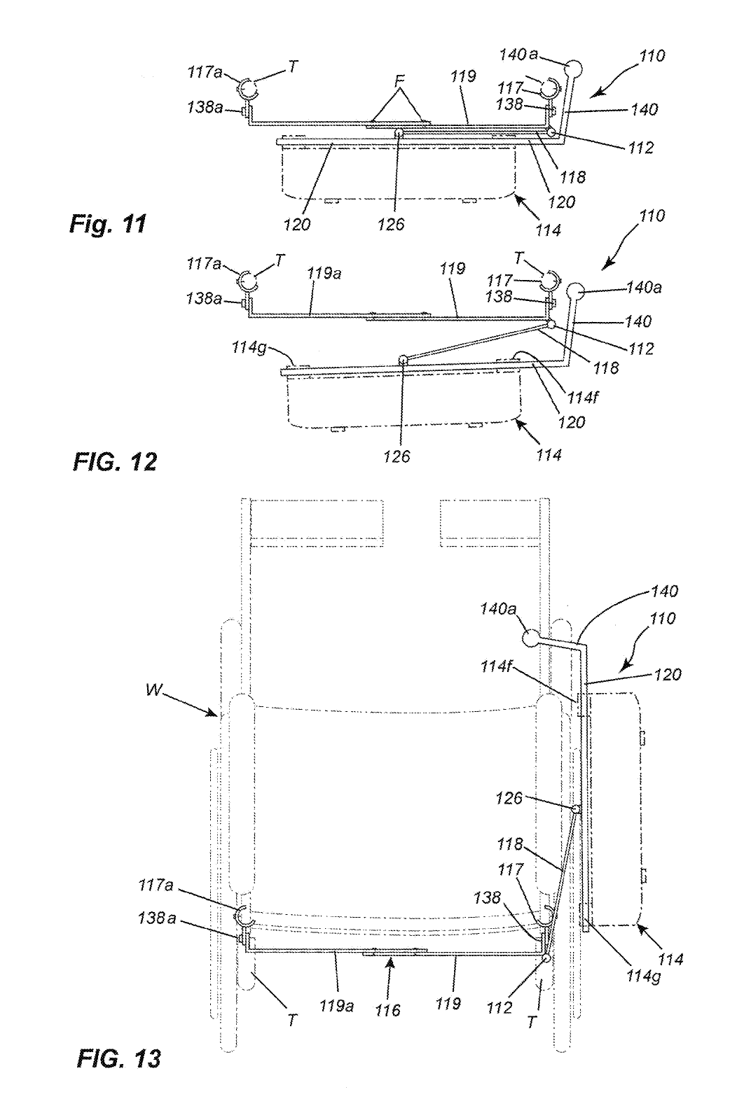

FIGS. 11 through 13 show the sequential operation in top plan views. In FIG. 11, the personal storage transfer device 110 is shown stored behind the backrest R. In FIG. 12, the user has grasped the handle 140a, in order to rotate the storage container 114 towards the side of an arm A of the wheelchair W, as shown in FIG. 13

The above description is meant to be exemplary only, and one skilled in the art will recognize that changes may be made to the embodiments described without departing from the scope of the invention disclosed. Modifications which fall within the scope of the present invention will be apparent to those skilled in the art, in light of a review of this disclosure, and such modifications are intended to fall within the appended claims.

1. A transfer device for moving a personal storage container from a storage position at the rear of a wheelchair to a deployed position at a side of the wheelchair where the wheelchair includes a backrest frame, the transfer device comprising:
a bracket adapted to be mounted to the backrest frame; and
a swivel mechanism including a first hinge leaf rotationally mounted to the bracket for rotation about a first axis, and a second hinge leaf rotationally mounted to the first hinge leaf about a second axis spaced apart from the first axis, the second hinge leaf having a portion adapted to mount the personal storage container, the swivel mechanism being configurable between the storage position and the deployed position, the portion adapted to mount the personal storage container moving along an arc contained within a plane between the storage and the deployed positions, the first and second axes being normal to the plane.

2. The transfer device as defined in claim 1, wherein the arc defines an angle of 270°.

3. The personal storage device as defined in claim 1, wherein the first hinge leaf is releasably mounted to the bracket.

4. The transfer device as defined in claim 1, wherein the bracket is a single bracket including a holding member configured to partially surround a tubular frame member of the backrest of a wheelchair and adapted to be fixed thereto.

5. The transfer device as defined in claim 4, wherein the single bracket has a journal bore defined therein and the first hinge leaf has a stem received in the journal bore for rotation about the first axis, wherein the stem is removable for separating the swivel mechanism from the bracket.

6. The transfer device as defined in claim 4, wherein the bracket includes a pivot assembly having a third axis parallel to the plane so that the swivel mechanism is adjustable about the third axis to change the orientation of the plane.

7. The transfer device as defined in claim 6, wherein the pivot assembly includes a first tab mounted to the holding member in a second plane normal to the plane, a hinge adapter with a second tab in a plane parallel to the second plane and rotationally engaged to the first tab for rotation about the third axis, and a movement adjustment member extending between the first tab and the hinge adapter for adjusting and limiting the rotation about the third axis, the first hinge leaf being rotationally mounted to the hinge adapter for rotation about the first axis.

8. The transfer device as defined in claim 7, wherein the movement adjustment member extends transversely to the third axis and spaced apart therefrom from the first tab to abut the second tab, the movement adjustment member having an adjustable length between the first and second tabs.

9. The transfer device as defined in claim 1, wherein the bracket includes more than one holding member, one for each tubular frame member of the wheelchair, and the bracket is adjustable in length between the holding members to accommodate different wheelchair width dimensions.

10. The transfer device as claimed in claim 9, wherein the first pivot axis between the bracket and the first hinge leaf is located at one end of the bracket spaced from a respective holding member.

11. The transfer device as defined in claim 10, wherein the second hinge leaf has a predetermined length suitable for mounting at least one surface of a personal storage container, and the second axis is located midway of the second hinge leaf.

12. The transfer device as defined in claim 10, wherein the second hinge leaf includes hanging means for supporting a container such as a back pack.

13. The transfer device as defined in claim 12, wherein a pull handle is provided at one end of the second hinge leaf.

14. The transfer device as defined in claim 9, wherein the bracket includes a pivot assembly adjacent each holding member having a third axis parallel to the plane so that the swivel mechanism is adjustable about the third axis to change the orientation of the plane.

15. The transfer device as defined in claim 14, wherein the pivot assembly includes a first tab mounted to the holding member in a second plane normal to the plane, a second tab in a plane parallel to the second plane and rotationally engaged to the first tab for rotation about the third axis, and a movement adjustment member interconnecting the first and second tabs for adjusting and limiting the rotation about the third axis, the first hinge leaf being rotationally mounted to the hinge adapter for rotation about the first axis.

16. The transfer device as defined in claim 15, wherein the movement adjustment member includes a cam follower extending from one of the first and second tabs, the cam follower extending parallel to the third axis and spaced apart therefrom, the other of the first and second tabs having an arcuate cam slot defined therein through which the cam follower is received.

17. A personal storage container assembly for a wheelchair movable between a storage position at the rear of a wheelchair to a deployed position at a side of the wheelchair where the wheelchair includes a backrest frame, the assembly comprising a personal storage container and a transfer device, the transfer device including a bracket adapted to be mounted to the backrest frame and a swivel mechanism including a first hinge leaf rotationally mounted to the bracket for rotation about a first axis, and a second hinge leaf rotationally mounted to the first hinge leaf about a second axis spaced apart from the first axis, the second hinge leaf mounting the personal storage container, the swivel mechanism being configurable between the storage position and the deployed position, the personal storage container moving along an arc contained within a plane between the storage and the deployed positions, the first and second axes being normal to the plane.

18. The assembly as defined in claim 17, wherein the arc defines an angle of 270°.

19. The assembly as defined in claim 17, wherein the first hinge leaf is releasably mounted to the bracket.

20. The transfer device as defined in claim 17, wherein the bracket includes a pivot assembly having a third axis parallel to the plane so that the swivel mechanism is adjustable about the third axis to change the orientation of the plane.
